(19) United States
(12) Patent Application Publication
(10) Pub. No.: US 2025/0338138 A1
(43) Pub. Date: Oct. 30, 2025

(54) DATA TRANSMITTING METHOD AND DATA TRANSMITTING DEVICE

(71) Applicant: REALTEK SEMICONDUCTOR CORPORATION, HSINCHU (TW)

(72) Inventor: PO-LIN HUANG, Hsinchu (TW)

(21) Appl. No.: 19/035,420

(22) Filed: Jan. 23, 2025

Related U.S. Application Data
(60) Provisional application No. 63/639,726, filed on Apr. 29, 2024.

(30) Foreign Application Priority Data
Jul. 8, 2024 (TW) 113125542

(51) Int. Cl. H04W 16/14

(52) U.S. Cl. CPC H04W 16/14

(57) ABSTRACT

A data transmitting method includes following steps: executing a channel availability check to multiple channels to check whether the channels comprise a radar signal; if a noise channel of the channels comprises the radar signal, executing a preamble puncturing to the noise channel corresponding to the radar signal in order to stop transmitting data through the noise channel; transmitting data through part channels excluding the noise channel of the channels, wherein a first bandwidth of the noise channel is less than or equal to a second bandwidth of the part channels; after a non-occupancy period ends, executing the channel availability check to the noise channel to check whether the noise channel comprises the radar signal; and if the noise channel does not comprise the radar signal, recovering the noise channel, and transmitting data through the noise channel and the part channels of the plurality of channels.

### BACKGROUND OF THE INVENTION

### 1. Field of the Invention

The present disclosure relates to a data transmitting method and a data transmitting device, especially to a data transmitting method and a data transmitting device that maintain transmission efficiency and avoid disconnection.

### 2. Description of Related Art

Dynamic frequency selection (DFS) stipulates that before using a channel, a channel availability check (CAC) must be executed, and the channel can be used if no radar signal is detected. Conversely, if a radar signal is detected, the channel cannot be used for a non-occupancy period. Additionally, if the channel is needed to be used again, another channel availability check must be executed.

Existing devices typically have only one set of circuits or no additional antennas to independently execute a channel availability check. When existing devices detect a radar signal, they must vacate the channel. If the bandwidth is 160 MHz, once the channel is vacated, the bandwidth will drop to 80 MHz. During this period, existing devices cannot use the channel, resulting in reduced transmission efficiency. Additionally, if the channel is needed to be used again, another channel availability check must be executed, leading to disconnection and inconvenience for users.

### SUMMARY OF THE INVENTION

In some aspects, an object of the present disclosure is to, but not limited to, provides a data transmitting method and a data transmitting device that makes an improvement to the prior art.

An embodiment of a data transmitting method of the present disclosure, executed by a processor reading at least one command stored in a memory, includes following steps: executing a channel availability check to a plurality of channels to check whether the plurality of channels comprise a radar signal; if a noise channel of the plurality of channels comprises the radar signal, executing a preamble puncturing to the noise channel corresponding to the radar signal in order to stop transmitting data through the noise channel; transmitting the data through part channels excluding the noise channel of the plurality of channels, wherein a first bandwidth of the noise channel is less than or equal to a second bandwidth of the part channels; after a non-occupancy period ends, executing the channel availability check to the noise channel to check whether the noise channel comprises the radar signal; and if the noise channel does not comprise the radar signal, recovering the noise channel, and transmitting the data through the noise channel of the plurality of channels and the part channels.

An embodiment of a data transmitting device of the present disclosure includes a memory and a processor. The memory is configured to store at least one command. The processor is configured to read the at least one command and execute following steps: executing a channel availability check to a plurality of channels to check whether the plurality of channels comprise a radar signal; if a noise channel of the plurality of channels comprises the radar signal, executing a preamble puncturing to the noise channel corresponding to the radar signal in order to stop transmitting data through the noise channel; transmitting the data through part channels excluding the noise channel of the plurality of channels, wherein a first bandwidth of the noise channel is less than or equal to a second bandwidth of the part channels; after a non-occupancy period ends, executing the channel availability check to the noise channel to check whether the noise channel comprises the radar signal; and if the noise channel does not comprise the radar signal, recovering the noise channel, and transmitting the data through the noise channel of the plurality of channels and the part channels.

Technical features of some embodiments of the present disclosure make an improvement to the prior art. The data transmitting method and the data transmitting device of the present disclosure only need to stop transmitting data through the noise channel of the plurality of channels, and the data transmitting method and the data transmitting device of the present disclosure can still transmit data through part channels of the plurality of channels to maintain transmission efficiency. If the present disclosure wants to recover the bandwidth, it does not need to stop transmission. Instead, the present disclosure can directly execute the channel availability check to the noise channel where data transmission was stopped. After passing the check, the noise channel can be recovered to resume data transmission, achieving the goal of zero wait DFS without needing to stop transmission.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data transmitting device of the present disclosure.

FIG. 2 shows an embodiment of a flow diagram of a data transmitting method of the present disclosure.

FIG. 3 shows an embodiment of an operation diagram of a data transmitting method of the present disclosure.

### DETAILED DESCRIPTION OF THE PREFERRED EMBODIMENTS

For avoiding the problem of transmission efficiency reduction and disconnection, the present disclosure provides a data transmitting method and a data transmitting device, which will be explained in detail as shown below.

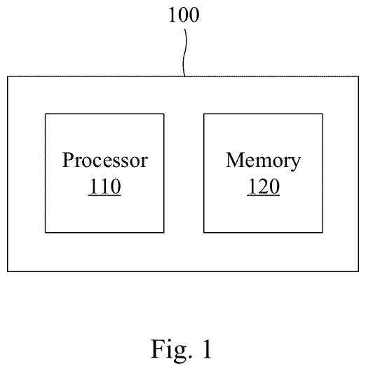

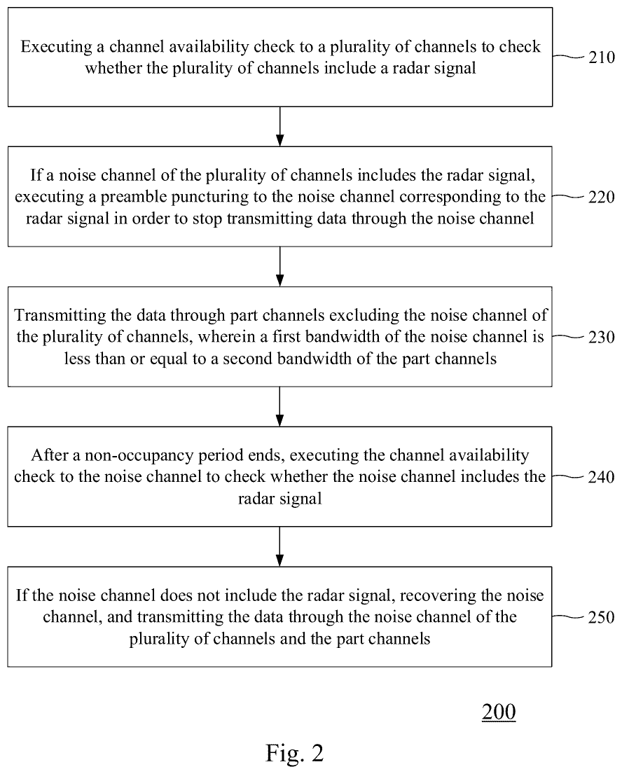

FIG. 1 shows an embodiment of a data transmitting device 100 of the present disclosure. As shown in the figure, the data transmitting device 100 includes a processor 110 and a memory 120. The memory 120 is utilized to store at least one command. The processor 110 is utilized to read at least one command to execute a data transmission process. For facilitating the understanding of operations of the data transmitting device 100, please refer to FIG. 2. FIG. 2 shows an embodiment of a flow diagram of a data transmitting method 200 of the present disclosure.

In step 210, executing a channel availability check to a plurality of channels to check whether the plurality of channels include a radar signal. For example, dynamic frequency selection (DFS) stipulates that before using a channel, a channel availability check (CAC) must be executed. The present disclosure executes a channel availability check to the channels to check whether the channels include a radar signal.

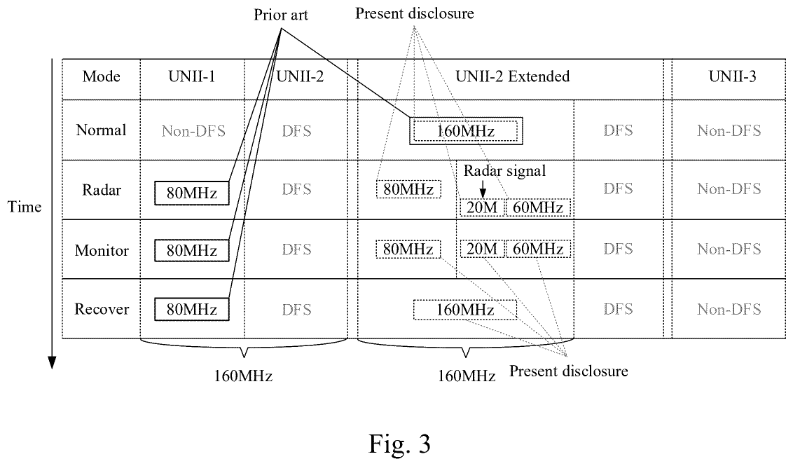

In step 220, if a noise channel of the plurality of channels includes the radar signal, executing a preamble puncturing to the noise channel corresponding to the radar signal in order to stop transmitting data through the noise channel. Referring to FIG. 3, the present disclosure can utilize per-20 MHz technology. If a radar signal as indicated in FIG. 3 is detected, the present disclosure can choose to execute a preamble puncturing to the 20 MHz where the radar signal appears in order to stop transmitting data through the aforementioned 20 MHz.

In step 230, transmitting the data through part channels excluding the noise channel of the plurality of channels, wherein a first bandwidth of the noise channel is less than or equal to a second bandwidth of the part channels. Referring to FIG. 3, the present disclosure can utilize per-20 MHz technology. In situation of stopping transmitting data through the 20 MHz where the radar signal appears, the present disclosure can still transmit data through 80 MHz and 60 MHz to maintain transmission efficiency.

In step 240, after a non-occupancy period ends, executing the channel availability check to the noise channel to check whether the noise channel includes the radar signal. In step 250, if the noise channel does not include the radar signal, recovering the noise channel, and transmitting the data through the noise channel of the plurality of channels and the part channels. Referring to FIG. 3, after a non-occupancy period ends, the present disclosure executes a channel availability check to the 20 MHz channel where the radar signal appears as indicated in FIG. 3. At the same time, the present disclosure maintains connection through part channels (e.g., 80 MHz and 60 MHz in the figure). Therefore, disconnection will be prevented. Subsequently, if the 20 MHz channel as indicated in FIG. 3 is no longer occupied by the radar signal, the present disclosure can recover the aforementioned 20 MHz channel, and a full bandwidth of 160 MHz can be utilized to transmit data. Therefore, after the non-occupancy period ends, the present disclosure can transmit data with 160 MHz, while prior art could only maintain data transmission with 80 MHz. The transmission efficiency of the present disclosure is improved by 100% compared to prior art. In some embodiments, the channel availability check time is about 60 seconds. However, the present disclosure is not limited to the above-mentioned embodiment, and the above-mentioned embodiment is merely an example for illustrating one of the implements of the present disclosure.

Overall, referring to FIG. 3, assuming bandwidth is 160 MHz, the channel is in the UNII-2 Extended band, and the radar signal appears on channel 116 as indicated in FIG. 3. Due to existing devices do not have ability to detect with a per-20 MHz technology, if existing devices want to continue transmitting data, it can only leave the aforementioned DFS channel and reduce the bandwidth to 80 MHz in the UNII-1 band. At this time, the ideal transmission speed will be halved, dropping from 160 MHz to 80 MHz. Additionally, existing devices typically have only one set of circuits or no additional antennas to independently execute the channel availability check. Subsequently, it can only maintain an 80 MHz bandwidth to transmit data on non-DFS channels.

If existing devices want to recover the bandwidth to 160 MHz, they need to stop transmitting data and then return to the DFS channel to execute the channel availability check again. However, this process would cause the connection to be interrupted, resulting in inconvenience for users. In contrast, if the present disclosure wants to recover the bandwidth to 160 MHz, it does not need to stop transmission. Instead, the present disclosure can directly execute the channel availability check to the noise channel where data transmission was stopped. After passing the check, the noise channel can be recovered to resume data transmission, achieving the goal of zero wait DFS without needing to stop transmission. Additionally, the present disclosure can utilize per-20 MHz technology. If the radar signal as indicated in FIG. 3 is detected in the channel, the present disclosure can choose to execute a preamble puncturing only for the 20 MHz where the radar signal appears in order to stop transmitting data through the aforementioned 20 MHz. Meanwhile, the present disclosure can still transmit data with 80 MHz and 60 MHz to maintain transmission efficiency.

In some embodiments, the second bandwidth of the part channels includes N times the first bandwidth of the noise channel, and N is a positive integer. Referring to FIG. 3, the second bandwidth (e.g., 80 MHz and 60 MHz) of the part channels can be 7 times the first bandwidth (e.g., the 20 MHz corresponding to the radar signal as indicated in FIG. 3) of the noise channel. In some embodiments, the first bandwidth of the noise channel ranges from 10 MHz to 30 MHz. However, the present disclosure is not limited to the above-mentioned embodiment, and the above-mentioned embodiment is merely an example for illustrating one of the implements of the present disclosure.

In some embodiments, during the non-occupancy period, the part channels transmit data, and execute an in-service monitoring. Referring to FIG. 3, during the non-occupancy period, the present disclosure can maintain the bandwidth of the part channels with 80 MHz and 60 MHz, and execute an in-service monitoring process. As a result, it can be seen that during the non-occupancy period, the present disclosure can transmit data with 140 MHz. The existing devices can only maintain a bandwidth of 80 MHz for data transmission, which means that the transmission efficiency of the present disclosure is improved by 75% compared to the existing devices. In some embodiments, the time of the non-occupancy period is about 30 minutes. However, the present disclosure is not limited to the above-mentioned embodiment, and the above-mentioned embodiment is merely an example for illustrating one of the implements of the present disclosure.

It is noted that the present disclosure is not limited to the embodiments as shown in FIG. 1 to FIG. 3, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data transmitting method and the data transmitting device of the present disclosure only need to stop transmitting data through the noise channel of the plurality of channels. The data transmitting method and the data transmitting device of the present disclosure can still transmit data through part channels of the plurality of channels to maintain transmission efficiency. In addition, the data transmitting method and the data transmitting device of the present disclosure only need to execute a channel availability check to the noise channel of the plurality of channels to determine whether to recover the noise channel. The present disclosure does not need to execute a channel availability check to part channels of the plurality of channels, thereby avoiding disconnection and preventing inconvenience for users.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data transmitting method, executed by a processor reading at least one command stored in a memory, comprising:
executing a channel availability check to a plurality of channels to check whether the plurality of channels comprise a radar signal;
if a noise channel of the plurality of channels comprises the radar signal, executing a preamble puncturing to the noise channel corresponding to the radar signal in order to stop transmitting data through the noise channel;
transmitting the data through part channels excluding the noise channel of the plurality of channels, wherein a first bandwidth of the noise channel is less than or equal to a second bandwidth of the part channels;
after a non-occupancy period ends, executing the channel availability check to the noise channel to check whether the noise channel comprises the radar signal; and
if the noise channel does not comprise the radar signal, recovering the noise channel, and transmitting the data through the noise channel of the plurality of channels and the part channels.

2. The data transmitting method of claim 1, wherein the second bandwidth of the part channels comprises N times the first bandwidth of the noise channel, and N is a positive integer.

3. The data transmitting method of claim 2, wherein the first bandwidth of the noise channel ranges from 10 MHz to 30 MHz.

4. The data transmitting method of claim 1, wherein transmitting the data through the part channels excluding the noise channel of the plurality of channels comprises:
during the non-occupancy period, transmitting the data, and executing an in-service monitoring by the part channels.

5. A data transmitting device, comprising:
a memory, configured to store at least one command; and
a processor, configured to read the at least one command and execute following steps:
executing a channel availability check to a plurality of channels to check whether the plurality of channels comprise a radar signal;
if a noise channel of the plurality of channels comprises the radar signal, executing a preamble puncturing to the noise channel corresponding to the radar signal in order to stop transmitting data through the noise channel;
transmitting the data through part channels excluding the noise channel of the plurality of channels, wherein a first bandwidth of the noise channel is less than or equal to a second bandwidth of the part channels;
after a non-occupancy period ends, executing the channel availability check to the noise channel to check whether the noise channel comprises the radar signal; and
if the noise channel does not comprise the radar signal, recovering the noise channel, and transmitting the data through the noise channel of the plurality of channels and the part channels.

6. The data transmitting device of claim 5, wherein the second bandwidth of the part channels comprises N times the first bandwidth of the noise channel, and N is a positive integer.

7. The data transmitting device of claim 6, wherein the first bandwidth of the noise channel ranges from 10 MHz to 30 MHz.

8. The data transmitting device of claim 5, wherein transmitting the data through the part channels excluding the noise channel of the plurality of channels comprises:
during the non-occupancy period, transmitting the data, and executing an in-service monitoring by the part channels.
